(19) United States
(12) Patent Application Publication
(10) Pub. No.: US 2003/0144897 A1
(43) Pub. Date: Jul. 31, 2003

(54) Finite life cycle demand forecasting

(76) Inventors: James W. Burruss, Vancouver, WA (US); Dorothea T. Kuettner, Mountain View, CA (US)

Correspondence Address: HEWLETT-PACKARD COMPANY, Intellectual Property Adiministration, P.O. Box 272400, Fort Collins, CO, 80527-2400, US

(21) Appl. No.: 10/061,008

(22) Filed: Jan. 30, 2002

(51) Int. Cl. G06F 17/60

(52) U.S. Cl. 705/10

(57) ABSTRACT

A demand forecasting system and method that provide highly flexible and efficient tools for forecasting demand for products that are characterized by finite life cycles are described. In accordance with this approach, the overall life cycle of a product is incorporated into the demand forecast in the form of a life cycle template that provides a high degree of control over the end of life point for a product. Individual factors (e.g., upcoming known events) affecting a forecast may be tracked and selectively applied to the forecast so that users may see the impact of each factor on product demand. The above-described forecasting tool also provides a framework for establishing an initial forecast and updating the forecast based upon the impact of inventory relative to sell-through and actual demand data. This approach avoids the need for manual override of forecasting data. In addition, this approach explicitly resolves the forecasting task into a set of independent factors that describe various aspects of end-customer demand and that may be activated selectively through a graphical user interface. In this way, this methodology improves the efficiency and refines the accuracy with which forecasters may generate a demand forecast and apply their own judgment and experience to the final forecast.

### TECHNICAL FIELD

This invention relates to systems and methods of forecasting demand that have particular applicability to products characterized by finite life cycles.

### BACKGROUND

Asset managers of large manufacturing enterprises, for example, computer manufacturers, electronics manufacturers and auto manufacturers, must determine the inventory levels of components and finished products that are needed to meet target end customer service levels (i.e., the fraction of customer orders that should be received by the requested delivery dates). For such manufacturing enterprises, the delivery of a finished product to an end customer typically involves a complex network of suppliers, fabrication sites, assembly locations, distribution centers and customer locations through which components and products flow. This network may be modeled as a supply chain that includes all significant entities participating in the transformation of raw materials or basic components into the finished products that ultimately are delivered to the end customer.

Business entities use demand forecasting techniques to plan the correct quantity of goods to be manufactured to meet customer needs. If the demand forecast is significantly different from the actual demand, there is an increase in the cost structure of the company. For example, when too much demand is forecasted, too many units will be manufactured, which leaves finished goods in inventory. Growing inventories lead to higher storage and maintenance costs. Business entities that do a better job of forecasting have significantly better control over their inventories and customer service levels.

Mathematical forecasting tools have been developed to increase the accuracy of demand forecasts. Many of these mathematical tools combine historical demand data with statistical analyses to determine a likely predicted value of demand for a product. In general, these forecasting techniques analyze the statistical patterns in historical demand data to predict future demand. Among these demand forecasting methods are: moving average techniques; exponential smoothing techniques; Box-Jenkins techniques; and multivariate regression techniques. Demand forecasting accuracy also is improved by applying human judgment to the predictions of the demand forecasting models. Forecasters validate the forecasts generated by the mathematical models and adjust the forecasts to accommodate events that are not incorporated into these models.

In some industries (e.g., the high technology industry) product life cycles are short and supply chain lead times for some components are relatively long. In this environment, traditional forecasting techniques, which often assume that the product life cycle is infinite, are challenged because there is a dearth of historic examples and patterns to analyze for predicting future demand.

### SUMMARY

The invention features a method and a tool for forecasting demand that have particular applicability to products characterized by finite life cycles.

In one aspect, the invention features a method of forecasting demand for a product. In accordance with this inventive method, an initial demand forecast is generated by imposing onto a set of product demand parameters a demand profile having a life cycle characterized by a growth phase, a maturity phase and a decline phase. An event-adjusted demand forecast is generated based upon a convolution of the initial demand forecast with a set of one or more impact profiles each representing an impact of a respective set of one or more events on product demand over the product life cycle.

As used herein, the term “convolution” refers broadly to a mathematical process of combining one or more profiles. Such a mathematical process may involve, for example, the steps of adding or multiplying, or both.

Embodiments in accordance with this aspect of the invention may include one or more of the following features.

The set of product demand parameters may include an estimate of mature monthly demand for the product, estimates of one or more parameters representing a length of the product life cycle (e.g., length estimates for the maturity and decline phases of the product life cycle demand profile), and an estimate of stock-in demand relative to an estimate of mature demand.

One or more of the impact profiles (e.g., seasonality, price drop, promotions, competitive product introductions and economic conditions impact profiles) may correspond to events having a multiplicative impact on demand for the product. One or more other impact profiles (e.g., deals, constrained product introductions, left-to-sell and bundling event impact profiles) may correspond to events having an additive impact on demand for the product.

In some embodiments, the life cycle demand profile corresponds to a normalized monthly demand profile that is derived from historical demand data of similar past products.

In some embodiments, an inventory-adjusted demand forecast is generated based upon a convolution of the event-adjusted demand forecast with a measure of channel inventory impact on product demand. The channel inventory impact measure may be computed based upon an estimate of aggregate channel weeks of supply. The step of computing the channel inventory impact measure may comprise computing a measure comparing the aggregate channel weeks of supply estimate and an estimate of an aggregate weeks of supply target for the channel. The step of computing the channel inventory impact measure also may comprise adjusting the comparison measure based upon an estimate of channel demand sensitivity to actual inventory levels relative to target inventory levels.

In some embodiments, a demand-adjusted demand forecast is generated based upon a convolution of the inventory-adjusted demand forecast with a measure of forecast error computed from a measure of actual demand and a measure of demand predicted by the inventory-adjusted demand forecast. The measure of forecast error may be smoothed in accordance with an exponentially-weighted moving average function.

In another aspect, the invention features a computer program for forecasting demand for a product in accordance with the above-described method.

In another aspect, the invention features a system for demand forecasting that includes a graphical user interface. The graphical user interface is configured to display a demand profile having a life cycle characterized by a growth phase, a maturity phase and a decline phase. The graphical user interface also is configured to receive values for a set of product demand parameters and to display an initial demand forecast corresponding to the life cycle demand profile modified in accordance with the set of product demand parameters. The graphical user interface is configured to display a set of one or more impact profiles each representing an impact of a respective set of one or more events on product demand over the product life cycle. The graphical user interface also is configured to receive values for modifying one or more of the impact profiles and to display an event-adjusted demand forecast corresponding to a convolution of the initial demand forecast with one or more impact profiles.

In some embodiments, the graphical user interface is configured to enable a user to selectively apply impact profiles to the initial demand forecast.

Other features and advantages of the invention will become apparent from the following description, including the drawings and the claims.

### DESCRIPTION OF DRAWINGS

FIG. 1 is a block diagram of an exemplary supply chain that includes multiple suppliers, a manufacturer that sells products to customers directly, and a manufacturer that sells products to customers indirectly through a supply channel that includes distributors (or resellers), retailers and valued-added resellers.

FIG. 2 is a block diagram of a system for forecasting demand for a product.

FIG. 3 is a flow diagram of a method of forecasting demand for a product.

FIG. 4A is a graph of a normalized life cycle demand profile for a representative product category.

FIG. 4B is a graphical user interface through which a user may enter values for a set of product demand parameters and view an initial demand forecast modified in accordance with the entered product demand parameter values.

FIG. 5 is a graphical user interface through which a user may define features of a deals event and view the resulting impact profile corresponding to that event.

FIG. 6 is a graphical user interface through which a user may define features of a left-to-sell event and view the resulting impact profile corresponding to that event.

FIG. 7 is a graph of an additive impact profile corresponding to a bundling event.

FIG. 8 is a graph of an additive impact profile corresponding to a constrained introduction event.

FIG. 9 is a graphical user interface through which a user may define features of seasonality-based events and view the resulting impact profile corresponding to those events.

FIG. 10 is a graphical user interface through which a user may define features of a price drop event and view the resulting impact profile corresponding to that event.

FIG. 11 is a graphical user interface through which a user may define features of a competitive introduction event and view the resulting impact profile corresponding to that event.

FIG. 12 is a graphical user interface through which a user may define features of a promotional event and view the resulting impact profile corresponding to that event.

FIG. 13 is a graphical user interface through which a user may define features of a local, national or global economic event and view the resulting impact profile corresponding to that event.

FIG. 14 is a flow diagram of a method of computing an event-adjusted demand forecast and an inventory-adjusted demand forecast.

FIG. 15 is a flow diagram of a method of computing an inventory-adjusted demand forecast from an event-adjusted demand forecast.

FIG. 16 is a graph representing an estimate of supply channel demand sensitivity plotted as a function of actual inventory levels relative to target inventory levels.

FIG. 17 is a flow diagram of a method of computing a demand-adjusted demand forecast from an event-adjusted and inventory-adjusted demand forecast.

FIG. 18A is a graphical user interface through which a user may selectively display one or more demand forecasts and one or more event-driven impact profiles.

FIG. 18B is the graphical user interface of FIG. 18A displaying an initial product life cycle forecast and a composite forecast corresponding to a final demand-adjusted demand forecast.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

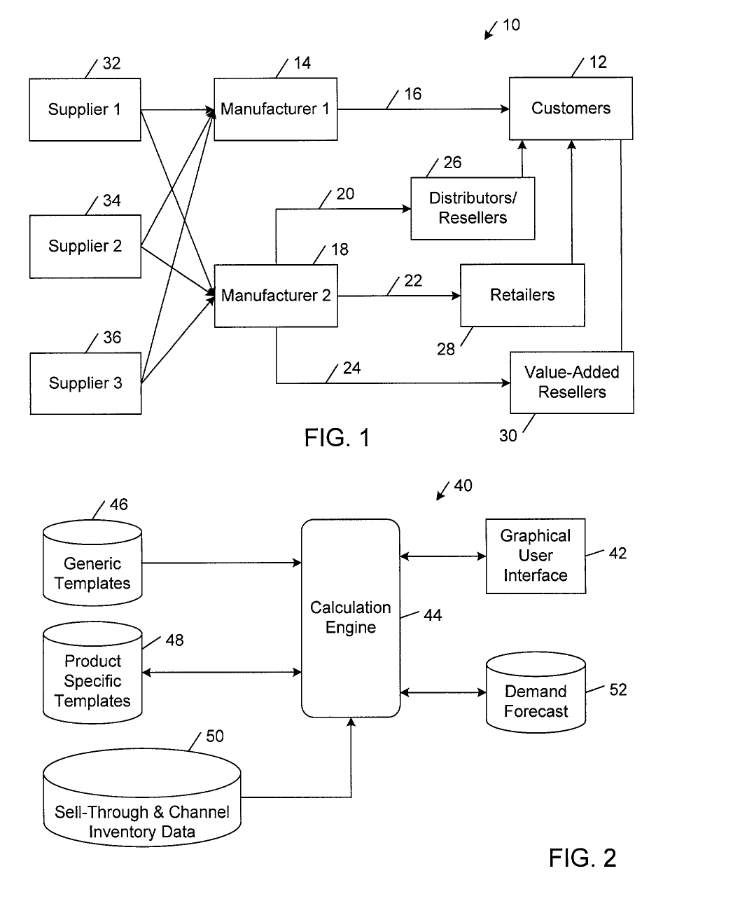

Referring to FIG. 1, in one illustrative embodiment, a simplified distribution system (or supply chain) 10 includes a set of end customers 12 expressing a cumulative demand level for a particular set of goods (or products) that drives the production of those goods. The goods are produced by a manufacturer 14 that sells products 16 to customers 12 directly, and by a manufacturer 18 that sells goods 20, 22, 24 to customers 12 indirectly through a supply channel that includes distributors (or resellers) 26, retailers 28 and valued-added resellers 30. Manufacturers 14, 18 may include respective manufacturing lines that are configured to assemble a plurality of products from component parts (or raw materials) that are supplied by a plurality of component part suppliers 32, 34, 36.

In operation, end customer demand drives orders, which are satisfied by shipments of products from inventories that are stored at various locations in the supply chain. As explained in detail below, production planners for each manufacturer 14, 18 schedule the delivery of finished goods so that the inventory levels are sufficient to cover both expected end customer demand and uncertainty in end customer demand.

In general, various demand forecasting techniques may be used to project future demand by end customers 12 for finished goods. The following discussion, however, assumes that the various products 16, 20, 22 and 24 that are supplied to end customers 12 are characterized by finite life cycles. In this context, the demand forecasting methodology described below improves forecasting accuracy by imposing onto the analytical framework a demand profile that is characterized by a growth phase, a maturity phase and a decline phase. In addition, this approach explicitly resolves the forecasting task into a set of independent factors that describe various aspects of end-customer demand and that may be activated selectively through a graphical user interface. In this way, this methodology improves the efficiency and refines the accuracy with which forecasters may generate a demand forecast and apply their own judgment and experience to the final forecast.

Referring to FIG. 2, in one embodiment, a demand forecasting system 40 may be implemented as follows. Demand forecasting system 40 may include a graphical user interface 42 and a calculation engine 44. Graphical user interface 42 provides a convenient and efficient way for a user (e.g., a forecaster) to enter data into the demand forecasting system 40, to visualize the impact of various events on a forecast, and to readily modify a forecast in accordance with new information (e.g., actual demand data, channel inventory data, and information relating to upcoming events). Calculation engine 44 operates upon data received from the user and data contained within data structures stored in various database tables, including a generic templates database 46, a product-specific templates database 48, and a database 50 containing sell-through and channel data. As explained in detail below, calculation engine 44 is operable to compute a demand forecast 52 for a particular product based upon a selected generic template and the demand data received for that product.

Demand forecasting system 40 may be implemented as one or more respective software modules operating on a computer. In one embodiment, the demand forecasting system may be implemented as a Microsoft® Access® Database utilizing Visual Basics for Applications (VBA) computer program operable as a spreadsheet tool in the Microsoft® Excel® application program, which is operable on a personal computer or a workstation. In general, the computer (or workstation) includes a processing unit, a system memory, and a system bus that couples the processing unit to the various components of the computer. The processing unit may include one or more processors, each of which may be in the form of any one of various commercially available processors. The system memory typically includes a read only memory (ROM) that stores a basic input/output system (BIOS) that contains start-up routines for the computer, and a random access memory (RAM). The system bus may be a memory bus, a peripheral bus or a local bus, and may be compatible with any of a variety of bus protocols, including PCI, VESA, Microchannel, ISA, and EISA. The computer also may include a hard drive, a floppy drive, and CD ROM drive that are connected to the system bus by respective interfaces. The hard drive, floppy drive, and CD ROM drive contain respective computer-readable media disks that provide non-volatile or persistent storage for data, data structures and computer-executable instructions. Other computer-readable storage devices (e.g., magnetic tape drives, flash memory devices, and digital video disks) also may be used with the computer. A user may interact (e.g., enter commands or data) with the computer using a keyboard and a mouse. Other input devices (e.g., a microphone, joystick, or touch pad) also may be provided. Information may be displayed to the user on a monitor. The computer also may include peripheral output devices, such as speakers and a printer. In addition, one or more remote computers may be connected to the computer over a local area network (LAN) or a wide area network (WAN) (e.g., the Internet).

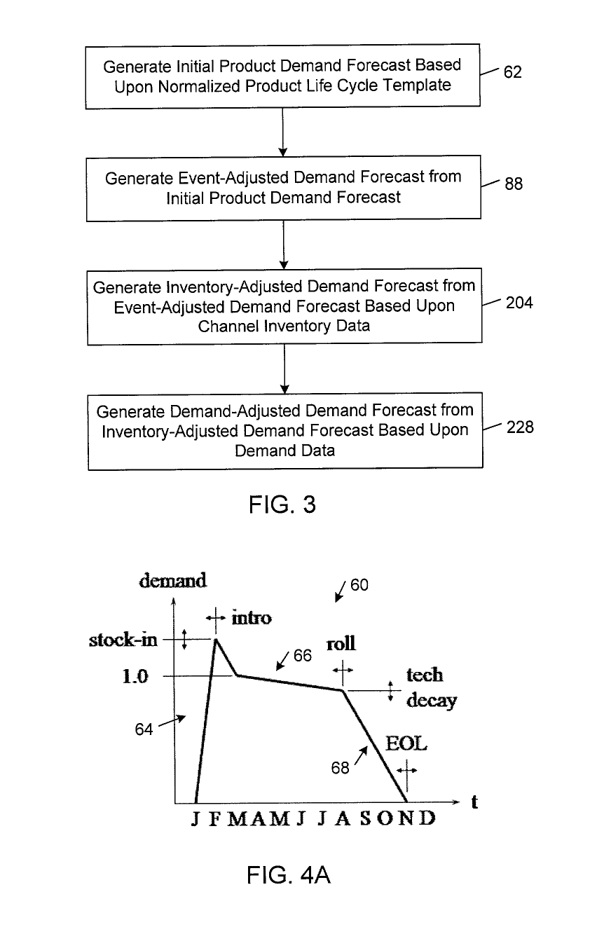

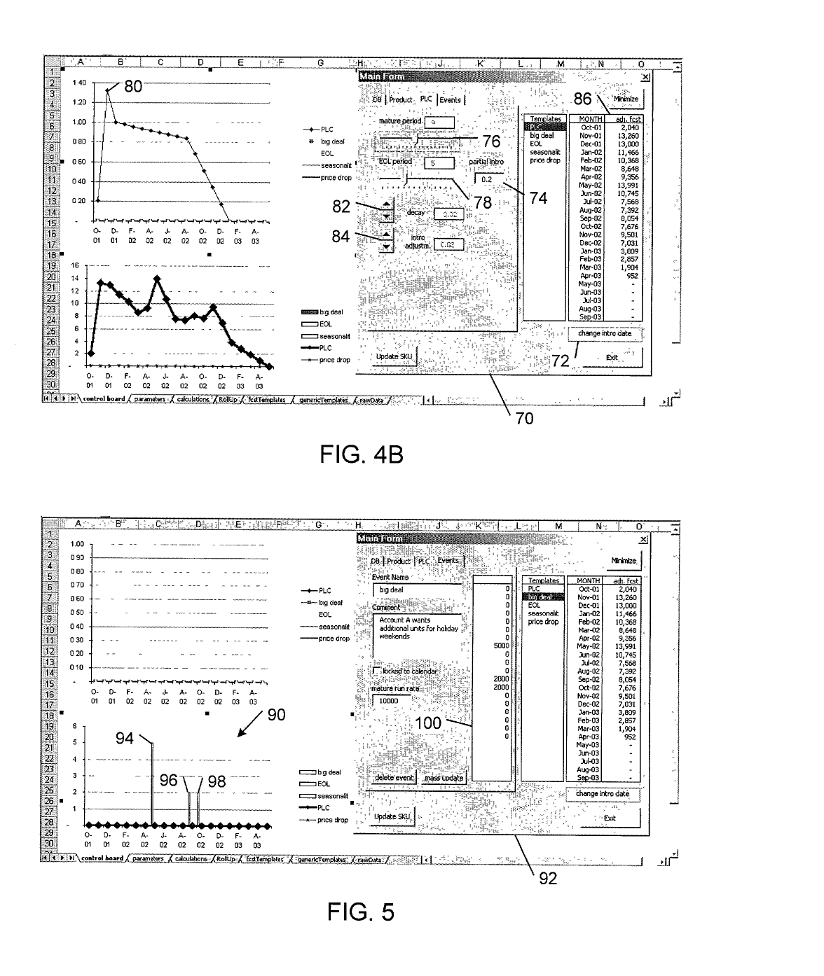

Referring to FIGS. 3-18B and initially to FIGS. 3, 4A and 4B, in one embodiment, demand forecasting system 40 may compute a demand forecast for a product as follows.

An initial product demand forecast is generated based upon a normalized product life cycle template (or profile) that is selected from a set of generic life cycle templates 60 (step 62; FIG. 3). As shown in FIG. 4A, each of the normalized product life cycle templates 60 describes a respective demand profile over a life cycle that is characterized by a growth phase 64, a maturity phase 66, and a decline phase 68. In addition to describing life cycle phases that are common to all products, each product life cycle template 60 describes certain features (e.g., magnitude of initial stock in spike, mature run rate, and end of life ramp down rate) that are assumed to be common to different products within the same product family (e.g., printers, scanners, all-in-one products, and appliances). Each product life cycle template 60 for a given product family may be constructed based upon an analysis of historical data observed for products in that family. Although very similar products may differ significantly in total life cycle demand and life cycle length, products in the same product family often have a similar monthly demand after being normalized with respect to life cycle length and mature demand volume. Accordingly, each of the generic product life cycle templates 60 corresponds to a monthly demand profile over the life cycle of a product family that is normalized with respect to life cycle length and cumulative demand.

In the illustrated embodiment, the demand profiles are normalized so that the demand at the beginning of the maturity phase 66 has a value of unity (1.0).

Referring to FIG. 4B, in one embodiment, a user may select and modify a generic product life cycle template through a graphical user interface 70. In this embodiment, the user first selects an appropriate generic product life cycle template (e.g., a life cycle template for the product family encompassing printers). After the generic product life cycle template has been selected, the user may modify certain features of the generic template to generate an initial scaled product-specific forecast. For example, the user may specify an introduction date by activating a “change intro date” button 72. A user may adjust the introduction from the default beginning of the specified month by changing the value in the “partial intro” box 74 from the default value of 0.0. A user also may specify estimates for life cycle length parameters, such as the lengths of the maturity phase 66 and the decline phase 68 (or end of life period), using sliding bar interfaces 76, 78. A user may adjust the magnitude of the initial stock-in peak 80 and the magnitude of the rate of decline in the mature run rate (i.e., the slope of the demand profile during the maturity phase 66) using incremental adjust button interfaces 82, 84. The monthly demand values for the adjusted product-specific life cycle template are displayed in window 86. The normalized product life cycle template is scaled in accordance with a specified estimate of the monthly demand rate at the beginning of the maturity period (i.e., the mature run rate) to produce a volume-scaled product life cycle template corresponding to an initial demand forecast.

Referring back to FIG. 3, after an initial demand forecast has been generated (step 62), the initial demand forecast is modified to produce an event-adjusted demand forecast (step 88; FIG. 3). In particular, the initial demand forecast is convolved with a set of one or more impact profiles to generate the event-adjusted demand forecast. Each impact profile represents the effect of a respective set of one or more events on product demand over the product life cycle. In the illustrated embodiment, a user may select impact profiles from a set of pre-generated, generic impact profiles that may be modified by the user; the user also may generate customized impact profiles from scratch. Generic impact profiles may be generated to describe the impact of any events that impact demand in a substantially regular and consistent way across product families or across all products. Each generic impact profile includes a set of one or more characteristic features or patterns that are gleaned from an analysis of patterns in observed historical demand data. In the illustrated embodiment, each impact profile may have either a multiplicative or an additive impact on the product demand profile over the product life cycle. In general, a multiplicative impact profile may be converted into an additive impact profile and vice versa.

As shown in FIGS. 5, 6, 7 and 8, among the common generic additive impact profiles that may be presented to the user are impact profiles describing the impact of the following events: deals events, left-to-sell events, bundling events, and constrained product introduction events.

Referring to FIG. 5, a user may modify a deals impact profile 90 through a graphical user interface 92. The deals impact profile includes one or more impulses 94, 96, 98 having peaks located on the dates on which the deals will be introduced and having magnitudes corresponding to the estimated additive impact of a deal, such as a marketing blitz or a bundling event, on the product demand profile. In the illustrated embodiment, the user may enter values for each of the impulse peaks on the respective introduction dates in a window 100 of graphical user interface 92.

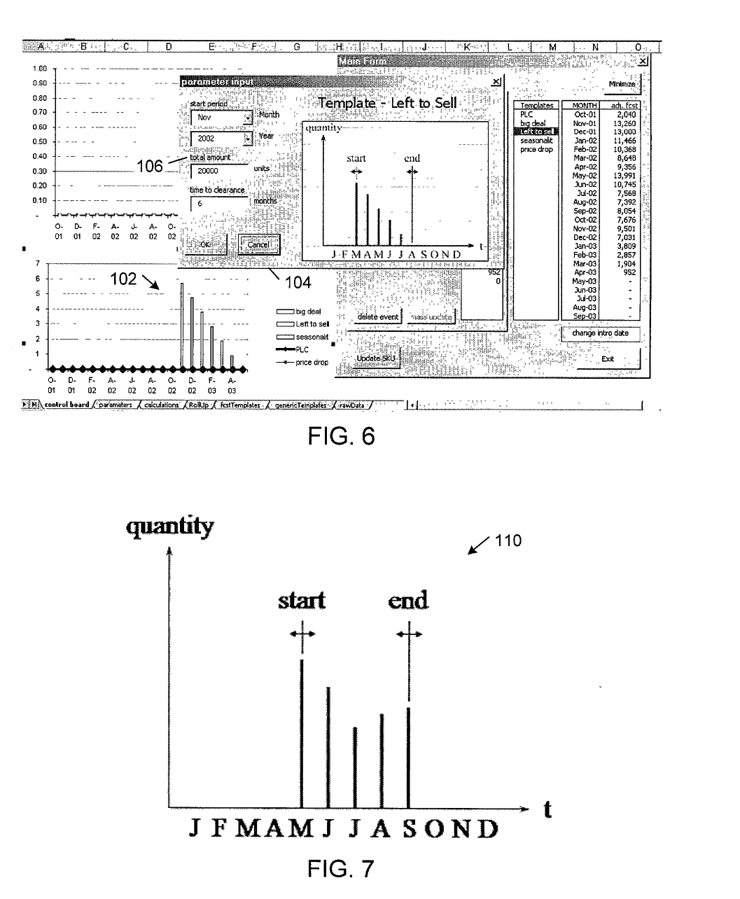

Referring to FIG. 6, a user may modify a left-to-sell impact profile 102 through a graphical user interface 104. The left-to-sell impact profile represents the estimated impact of events, such as price drops, introduced near the end of a products life cycle to boost product demand in an effort to clear product inventories. The left-to-sell impact profile allows a user to account for the manufacturer's end-of-life inventory in the demand forecast. In the illustrated embodiment, the left-to-sell impact profile 102 is characterized by a start date and an end date and a series of monthly impulses with magnitudes that drop-off linearly from a high point at the start date to zero at the end date. The sum of the left-to-sell impulses corresponds to the total amount 106 (in units) of product to clear at the end of the product's life.

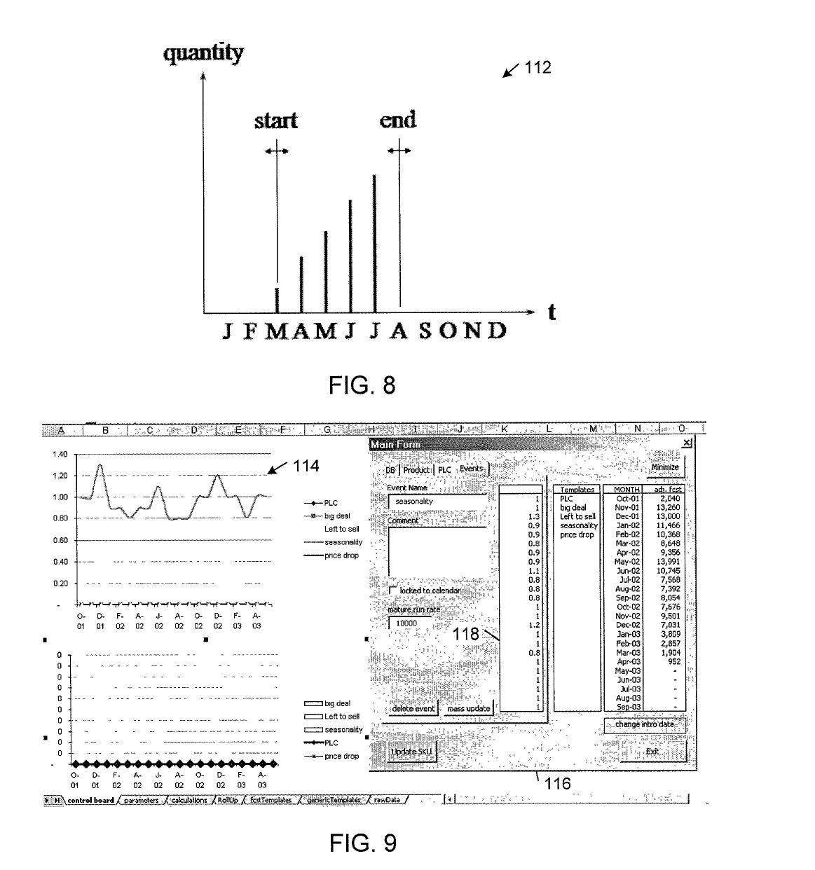

Referring to FIGS. 7 and 8, a user also may be presented with other additive impact profiles, including a bundles impact profile 110 and a constrained introduction impact profile 112. The bundles impact profile 110 is characterized by a series of impulses occurring monthly from a start date to an end date. The monthly impulses represent the additive impact of a bundling event on the demand forecast for a product. The magnitudes of the bundling impulses may follow a profile characterized by relative high points at the start and end dates and a relative low point at a date occurring between the start date and the end date (e.g., as shown in FIG. 7). The constrained introduction profile 112 is intended to estimate the likely additive impact of one or more events that occur at the beginning of the product life cycle and interfere with the shipment of products to end customers 12 or to entities in the supply channel. In the illustrated embodiment, the constrained introduction profile 112 is characterized by a series of monthly impulses with magnitudes that increase from a start date to an end date that typically acts as a delay of the initial stock-in peak 82 of the selected initial demand forecast.

As shown in FIGS. 9, 10, 11, 12 and 13, among the common generic multiplicative impact profiles that may be presented to the user are impact profiles describing the impact of the following events: seasonality-based events, price drop events, competitive product introduction events, promotions, and events relating to local, national or global economic conditions.

Referring to FIG. 9, a user may modify a generic seasonality-based impact profile 114 through a graphical user interface 116. Seasonality-based impact profile 114 includes features that are derived from a statistical analysis of demand data and represent the influence of seasonal variations on demand for a product family. The multiplicative impact of the seasonality-based impact profile 114 on each month of the product demand profile over the product life cycle may be presented to the user in a window 118. The user may modify one or more of these multiplicative impact values using graphical user interface 116.

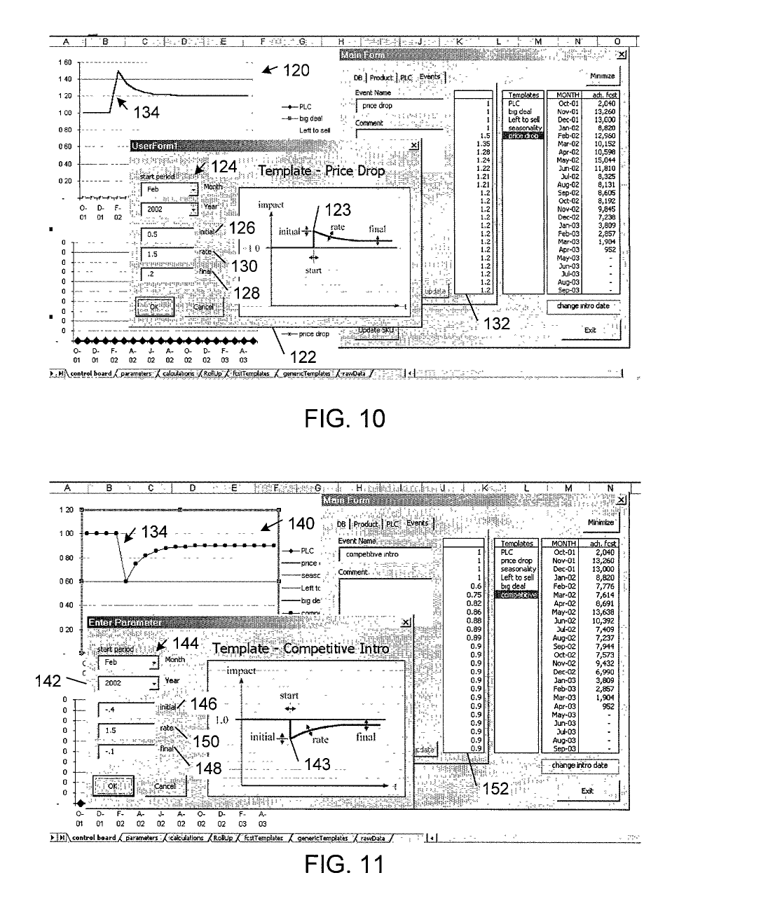

Referring to FIG. 10, a user may modify a generic price drop impact profile 120 through a graphical user interface 122. The price drop impact profile has an initial peak 123 occurring at a specified start date and a subsequent exponential drop off period, and is defined by the following parameters: start period 124, peak value 126, final value 128, and curvature (or drop off rate) value 130. In the illustrated embodiment, the user may enter values for each of the characteristic parameter values 124-130 in the corresponding text boxes. The multiplicative impact of the price drop impact profile 120 on each month of the product demand profile over the product life cycle may be presented to the user in a window 132. In some embodiments, the price drop impact profile 120 may have a sloped introductory period 134 during which time the profile rises from an initial value of 1.0 to the peak value 126.

Referring to FIG. 11, a user may modify a competitive introduction impact profile 140 through a graphical user interface 142. The competitive introduction impact profile corresponds to the demand impact of an introduction of a competing product. The competitive introduction impact profile has an initial low point 143 occurring at a specified start date and a subsequent exponential rise period, and is defined by the following parameters: start period 144, peak value 146, final value 148, and curvature (or rate of increase) value 150. In the illustrated embodiment, the user may enter values for each of the characteristic parameter values 144-150 in the corresponding text boxes. The multiplicative impact of the competitive introduction impact profile 140 on each month of the product demand profile over the product life cycle may be presented to the user in a window 152. In some embodiments, the competitive introduction impact profile 140 may have a sloped introductory period 154 during which time the profile drops from an initial value of 1.0 to the low point value 143.

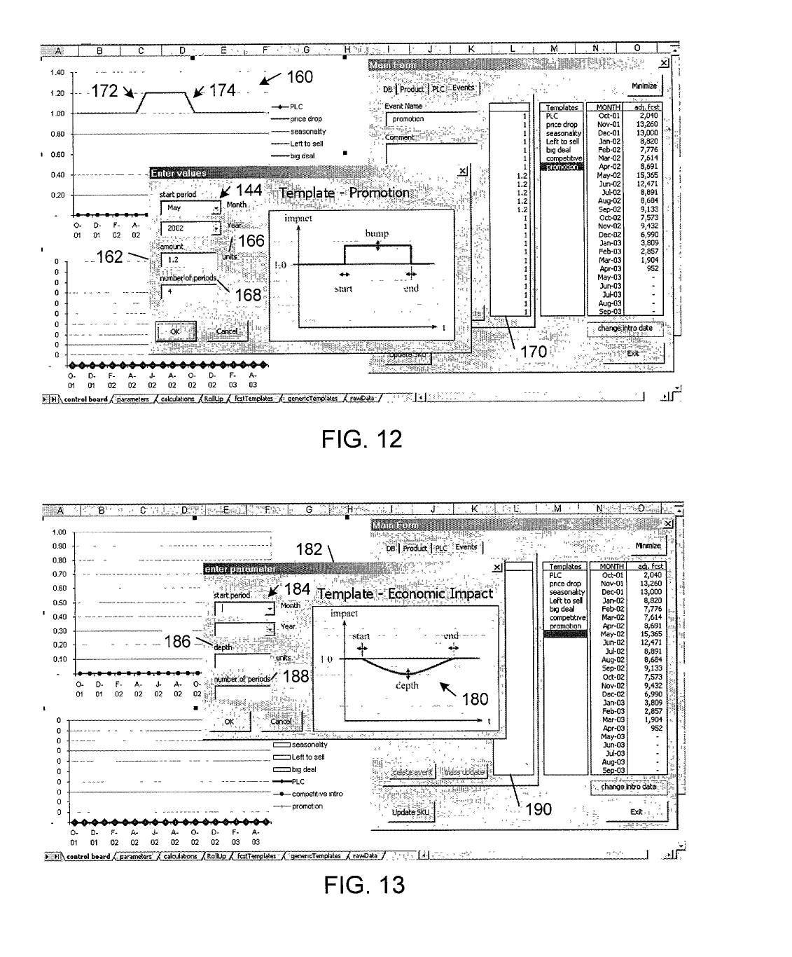

Referring to FIG. 12, a user may modify a promotions impact profile 160 through a graphical user interface 162. The promotions impact profile corresponds to the multiplicative impact of a promotional event on the demand for a product. The promotions impact profile has a constant value greater than unity (1.0) from a specified start date to a specified end date, and is defined by the following parameters: a start period 164, a constant value (or amount) 166, and a length 168 (in periods). In the illustrated embodiment, the user may enter values for each of the characteristic parameter values 164-168 in the corresponding text boxes. The multiplicative impact of the promotions impact profile 160 on each month of the product demand profile over the product life cycle may be presented to the user in a window 170. In some embodiments, the promotions impact profile 160 may have a sloped beginning and ending periods 172, 174 during which times the profile respectively rises from unity to the constant value 166 and drops from the constant value 166 back to unity.

Referring to FIG. 13, a user may modify an economic conditions impact profile 180 through a graphical user interface 182. The economic conditions impact profile is designed to account for the positive or negative impact of local, national or global economic conditions on demand for a product. In the illustrated embodiment, economic conditions impact profile 180 has a curved profile that dips below (or rises above; during favorable economic times) unity from specified start and end dates to a low point occurring between the specified start and end dates, and is defined by the following parameters: start period 184, a depth (or height) value 186, and a length 188. In the illustrated embodiment, the user may enter values for each of the characteristic parameter values 184-188 in the corresponding text boxes. The multiplicative impact of the economic conditions impact profile 180 on each month of the product demand profile over the product life cycle may be presented to the user in a window 190.

Still other generic impact profiles may be presented to the user for modification and application to the initial demand forecast. In general, any regular and predictable event-driven impacts may be modeled as a multiplicative or additive impact profile and presented to the user for use in refining the initial demand forecast.

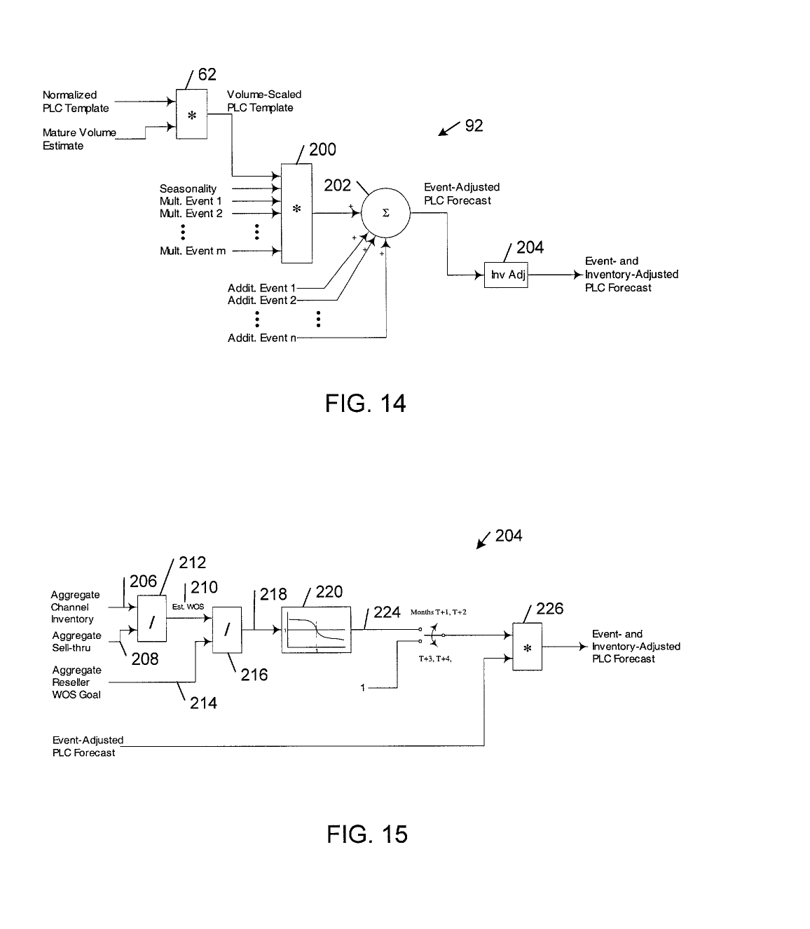

Referring back to FIG. 3 and to FIG. 14, in one embodiment, the event-adjusted demand forecast may be generated from the initial demand forecast as follows (step 88). The volume-scaled product life cycle template corresponding to the initial demand forecast is convolved with the seasonality and other multiplicative impact profiles (step 200; FIG. 3). In the illustrated embodiment, the convolution process involves multiplying the corresponding monthly values of the initial demand forecast and each of the selected multiplicative impact profiles. The resulting modified initial demand forecast is convolved with the additive impact profiles to produce an event-adjusted produce life cycle forecast (step 202). In the illustrated embodiment, the convolution process involves adding the corresponding monthly values of the initial demand forecast and each of the additive impact profiles.

As shown in FIGS. 3, 14, 15 and 16, in one embodiment, an inventory-adjusted demand forecast may be generated from the event-adjusted demand forecast based upon channel inventory and sell-through data (step 204; FIG. 3).

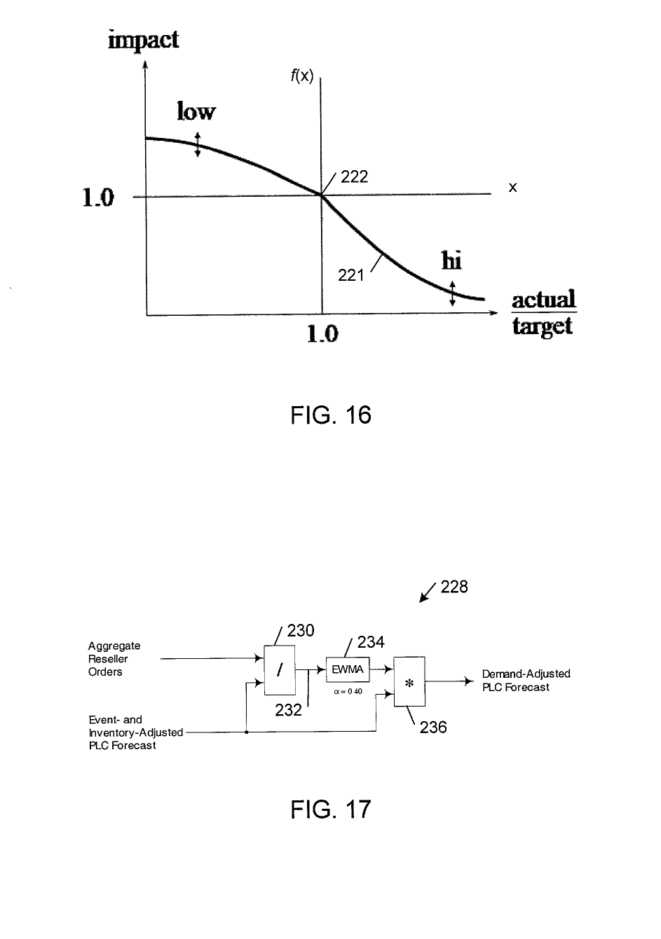

In this embodiment, the current aggregate channel inventory level 206 is divided by the current aggregate channel sell-through 208 to obtain an estimate of the weeks of supply 210 in the channel (step 212; FIG. 15). The weeks of supply estimate 210 is divided by an estimate of the aggregate weeks of supply goal (or target) 214 for the channel (step 216; FIG. 15). The resulting quotient 218 is adjusted in accordance with a function that corresponds to an estimate of channel demand sensitivity as a function of actual inventory levels relative to inventory targets (step 220; FIG. 15). As shown in FIG. 16, in the illustrated embodiment, the quotient 218 (x) is modified in accordance with a sigmoid function 221 (ƒ(x)) having a transition (or inflection) point 222 corresponding to ((x, ƒ(x))=(1, 1)). The particular parameters defining the sigmoid function may be derived from an analysis of historical data for the channel. In one embodiment, the resulting channel inventory adjustment factor 224 is convolved with the first two months (T+1, T+2) of the event-adjusted product life cycle forecast to produce an inventory-adjusted product life cycle forecast (step 226; FIG. 15). In this embodiment, the channel inventory adjustment factor 224 is not applied to the remaining months (T+3, T+4, . . . ) of the event-adjusted product life cycle forecast because the reliability of this factor tends to drop off significantly for time periods beyond one or two months. In other embodiments, the channel inventory adjustment factor 224 may be applied to a different number of time periods of the event-adjusted product life cycle forecast depending upon the perceived reliability of this factor for each future time period.

Referring to FIGS. 3 and 17, in one embodiment, a demand-adjusted demand forecast is generated from the inventory-adjusted demand forecast based upon actual demand data as follows (step 228; FIG. 3). For manufacturers selling directly to end customers, end customer demand may be obtained from actual customer orders, whereas for manufacturers selling through a supply channel, end customer demand may be estimated from the aggregate number of orders received from entities in the supply channel. As data comes in monthly, the measure of demand for the current period is divided by the corresponding inventory-adjusted demand forecast value (step 230; FIG. 17). The resulting quotient 232 is smoothed in accordance with an exponentially-weighted moving average (EWMA) function (step 234; FIG. 17). The inventory-adjusted demand forecast is convolved with the latest smoothed quotient for all future periods to obtain a demand-adjusted product life cycle demand forecast (step 236; FIG. 17).

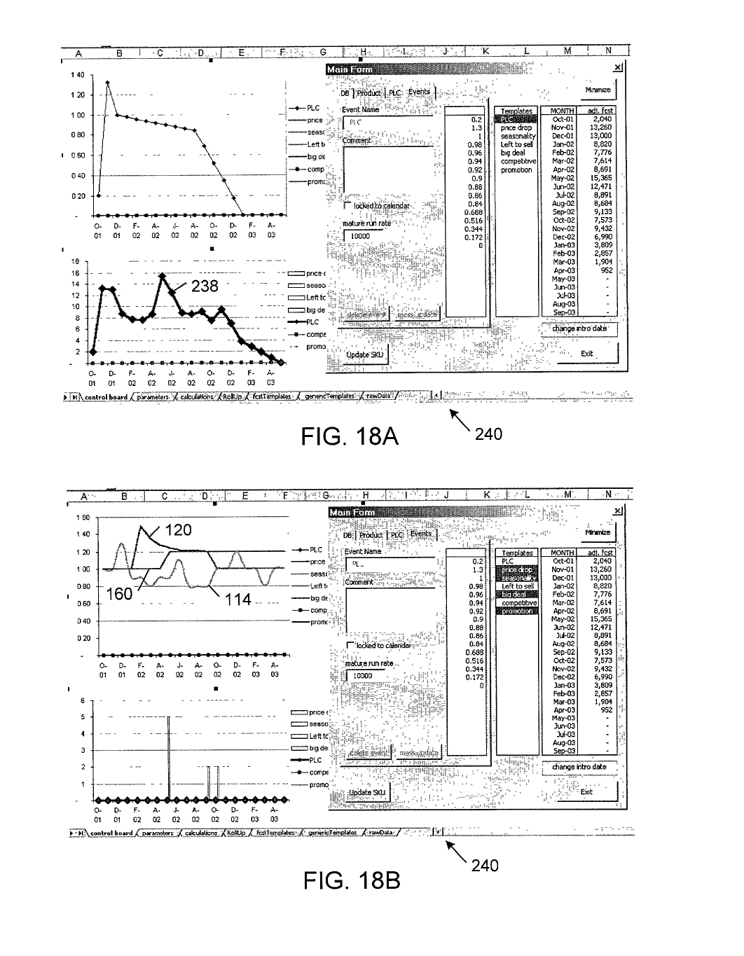

As shown in FIGS. 18A and 18B, in one embodiment, the latest demand-adjusted demand (or composite) forecast 238 may be displayed in a graphical user interface 240. A user may selectively view one or more of the computed demand forecasts and one or more of the computed impact profiles in graphical user interface 240. In some embodiments, a user may aggregate multiple product demand forecasts in accordance with one or more user-defined levels (e.g., price bands).

In sum, the above-described demand forecasting system provides a highly flexible and efficient tool for forecasting demand for products that are characterized by finite life cycles. In accordance with this approach, the overall life cycle of a product is incorporated into the demand forecast in the form of a life cycle template that provides a high degree of control over the end of life point for a product. This approach also incorporates the impact of inventory relative to sell-through so that the impact on reseller replenishment orders based on how well a product is doing in the marketplace may be factored into the forecast. Upcoming known events (e.g., price drops, bundles and promotions) readily may be incorporated into a forecast simply by specifying an impact profile for each event. Individual factors affecting a forecast may be tracked and selectively applied to the forecast so that users may see the impact of each factor on product demand. The above-described forecasting tool also provides a framework for establishing an initial forecast and updating the forecast based upon actual data that avoids the need for manual override of data contained in, for example, individual spreadsheet cells.

Other embodiments are within the scope of the claims.

Although systems and methods have been described herein in the context of a particular computing environment, these systems and methods are not limited to any particular hardware or software configuration, but rather they may be implemented in any computing or processing environment, including in digital electronic circuitry or in computer hardware, firmware or software. In general, the component engines of the demand forecasting system 40 may be implemented, in part, in a computer process product tangibly embodied in a machine-readable storage device for execution by a computer processor. In some embodiments, these systems preferably are implemented in a high level procedural or object oriented processing language; however, the algorithms may be implemented in assembly or machine language, if desired. In any case, the processing language may be a compiled or interpreted language. The methods described herein may be performed by a computer processor executing instructions organized, for example, into process modules to carry out these methods by operating on input data and generating output. Suitable processors include, for example, both general and special purpose microprocessors. Generally, a processor receives instructions and data from a read-only memory and/or a random access memory. Storage devices suitable for tangibly embodying computer process instructions include all forms of non-volatile memory, including, for example, semiconductor memory devices, such as EPROM, EEPROM, and flash memory devices; magnetic disks such as internal hard disks and removable disks; magneto-optical disks; and CD-ROM. Any of the foregoing technologies may be supplemented by or incorporated in specially designed ASICs (application-specific integrated circuits).

The above embodiments are described in connection with a particular supply chain model for conventional end-products (or goods). These embodiments, however, also may be used in connection with any type of product, service or production task item that a business entity may produce or consume. Such items may include products, services, and resources sold to end-customers or used internally as intermediate items in the production of other products or services.

In addition, other embodiments may allow a user to modify the generic product life cycle templates and the generic impact profile templates graphically. For example, each generic product life cycle and impact profile template may be defined by a respective vector-based demand-time plot that includes one or more nodes that correspond to features of the demand profile that may be adjusted by a user. The nodes may be selected with a pointing device and dragged to different locations corresponding to different numerical adjustments to the generic templates. In still other embodiments, a user simply may enter a string of values corresponding to adjustments to certain features of a selected generic product life cycle template.

Still other embodiments are within the scope of the claims.

What is claimed is:

1. A method of forecasting demand for a product, comprising:
generating an initial demand forecast by imposing onto a set of product demand parameters a demand profile having a life cycle characterized by a growth phase, a maturity phase and a decline phase; and
generating an event-adjusted demand forecast based upon a convolution of the initial demand forecast with a set of one or more impact profiles each representing an impact of a respective set of one or more events on product demand over the product life cycle.

2. The method of claim 1, wherein the set of product demand parameters includes an estimate of the mature demand for the product.

3. The method of claim 1, wherein the set of product demand parameters includes estimates of one or more parameters representing a length of the product life cycle.

4. The method of claim 3, wherein the life cycle length parameters include length estimates for the maturity and decline phases of the product life cycle demand profile.

5. The method of claim 1, wherein the set of product demand parameters includes an estimate of stock-in demand relative to an estimate of mature demand.

6. The method of claim 1, wherein one or more of the impact profiles correspond to events having a multiplicative impact on demand for the product.

7. The method of claim 6, wherein among the multiplicative impact profiles are a seasonality impact profile, a price drop impact profile, a promotions impact profile, a competitive product introduction impact profile, and an economic conditions impact profile.

8. The method of claim 1, wherein one or more of the impact profiles correspond to events having an additive impact on demand for the product.

9. The method of claim 8, wherein among the additive impact profiles are a deals impact profile, a constrained product introduction impact profile, a left-to-sell impact profile and an impact profile corresponding to a bundling event.

10. The method of claim 1, wherein the life cycle demand profile corresponds to a normalized monthly demand profile derived from historical demand data.

11. The method of claim 1, further comprising generating an inventory-adjusted demand forecast based upon a convolution of the event-adjusted demand forecast with a measure of channel inventory and sell-through impact on product demand.

12. The method of claim 11, further comprising computing the channel inventory impact measure based upon an estimate of aggregate channel weeks of supply.

13. The method of claim 12, wherein computing the channel inventory impact measure comprises computing a measure comparing the aggregate channel weeks of supply estimate and an estimate of an aggregate weeks of supply target for the channel.

14. The method of claim 13, wherein computing the channel inventory impact measure further comprises adjusting the comparison measure based upon an estimate of channel demand sensitivity to actual inventory levels relative to target inventory levels.

15. The method of claim 11, further comprising generating a demand-adjusted demand forecast based upon a convolution of the inventory-adjusted demand forecast with a measure of forecast error computed from a measure of actual demand and a measure of demand predicted by the inventory-adjusted demand forecast.

16. The method of claim 15, further comprising smoothing the measure of forecast error in accordance with an exponentially-weighted moving average function.

17. A computer program for forecasting demand for a product, the computer program residing on a computer-readable medium and comprising computer-readable instructions for causing a computer to:
generate an initial demand forecast by imposing onto a set of product demand parameters a demand profile having a life cycle characterized by a growth phase, a maturity phase and a decline phase; and
generate an event-adjusted demand forecast based upon a convolution of the initial demand forecast with a set of one or more impact profiles each representing an impact of a respective set of one or more events on product demand over the product life cycle.

18. A system for forecasting demand for a product, comprising a graphical user interface configured to:
display a demand profile having a life cycle characterized by a growth phase, a maturity phase and a decline phase;
receive values for a set of product demand parameters;
display an initial demand forecast corresponding to the life cycle demand profile modified in accordance with the set of product demand parameters;
display a set of one or more impact profiles each representing an impact of a respective set of one or more events on product demand over the product life cycle;
receive values for modifying one or more of the impact profiles; and
display an event-adjusted demand forecast corresponding to a convolution of the initial demand forecast with one or more impact profiles.

19. The system of claim 18, wherein the graphical user interface is configured to enable a user to selectively apply impact profiles to the initial demand forecast.

20. The system of claim 18, further comprising a calculation engine configured to:
compute an inventory-adjusted demand forecast based upon a convolution of the event-adjusted demand forecast with a measure of channel inventory impact on product demand; and compute
a demand-adjusted demand forecast based upon a convolution of the inventory-adjusted demand forecast with a measure of forecast error computed from a measure of actual demand and a measure of demand predicted by the inventory-adjusted demand forecast.
